(19) United States
(12) Patent Application Publication
(10) Pub. No.: US 2023/0216153 A1
(43) Pub. Date: Jul. 6, 2023

(54) BATTERY AND BATTERY PACK

(71) Applicant: BYD COMPANY LIMITED, Shenzhen (CN)

(72) Inventors: Xinyue WANG, Shenzhen (CN); Da ZHANG, Shenzhen (CN); Wen LUO, Shenzhen (CN)

(21) Appl. No.: 18/176,145

(22) Filed: Feb. 28, 2023

Related U.S. Application Data
(63) Continuation of application No. PCT/CN2021/114101, filed on Aug. 23, 2021.

(30) Foreign Application Priority Data
Aug. 31, 2020 (CN) 202010900497.8

(51) Int. Cl. H01M 50/533; H01M 50/169

(52) U.S. Cl. CPC H01M 50/533; H01M 50/169

(57) ABSTRACT

A cell has at least one pole core. Each pole core has a plurality of tabs. The plurality of tabs are converged and then soldered to a cover plate of a battery to form a solder joint. When the pole core is parallel to the cover plate before convergence or after the pole core is unfolded, a spacing between the pole core and the solder joint is determined by a thickness of the pole core, a tab bending angle of the tab, and a width of a tab protection plate at the solder joint.

### CROSS-REFERENCE TO RELATED APPLICATIONS

The present disclosure is a bypass continuation application of PCT International Application No. PCT/CN2021/114101, filed on Aug. 23, 2021, which claims priority to and benefits of Chinese Patent Application No. 202010900497.8, entitled “BATTERY AND BATTERY PACK” and filed by BYD Co., Ltd. on Aug. 31, 2020, which are incorporated herein by reference in their entireties.

### FIELD

The present disclosure relates to the field of batteries, and in particular, to a battery and a battery pack having same.

### BACKGROUND

In the related art, a plurality of tabs of a pole core are converged and then soldered together. The position of the solder joint affects the length of the tab free region. When the pole core is parallel to the cover plate before convergence or after the pole core is unfolded, if the spacing between the pole core and the mid-point position of the solder joint is designed too small, the tab is easily pulled after bending, which causes the tab to be torn, resulting in that some electrode plates cannot output electricity, leading to capacity loss of the cell.

If the spacing between the pole core and the mid-point position of the solder joint is designed too large, the movable length of the tab is increased, and a larger bending space is required in order to accommodate the tab. However, the larger bending space leads to capacity loss of the cell. If the bending space is not increased, the tab will be compressed, which is likely to cause the positive and negative electrodes to come into contact with each other, endangering the safety of the battery.

### SUMMARY

The present disclosure aims to resolve at least one of the technical problems existing in the prior art. In view of this, an objective of the present disclosure is to propose a battery, which can prevent the tab from being pulled after bending, can avoid the capacity loss of the cell, and can also prevent the tab from being compressed, thereby improving the safety of the battery.

The present disclosure further proposes a battery pack including the above-mentioned battery.

The battery according to the present disclosure includes a cell, where the cell has at least one pole core, each pole core has a plurality of tabs, the plurality of tabs are converged and then soldered to a cover plate of the battery to form a solder j oint, and when the pole core is parallel to the cover plate before convergence or after the pole core is unfolded, a spacing between the pole core and the solder joint is determined by a thickness of the pole core, a tab bending angle of the tab, and a width of a tab protection plate at the solder joint.

The battery according to the present disclosure offers a more desirable spacing between the pole core and the solder joint, which can prevent the tab from being pulled after bending, and can prevent the tab from being torn, so as to avoid capacity loss of the cell; and also offers a desirable movable length of the tab and a desirable bending space, so as to avoid capacity loss of the cell, and prevent the tab from being compressed, thereby improving the safety of the battery in use.

In some examples of the present disclosure, the spacing between the pole core and the solder joint is L₁, the thickness of the pole core is D, the width of the tab protection plate is d₁, the tab bending angle of the tab is A, and the following relational expression is satisfied:

$${\text{L}}_{1} \text{=} \text{D} / 2 ∗ tan \text{A+} {\text{d}}_{1} / 2 .$$

In some examples of the present disclosure, 45°≤A≤135°.

In some examples of the present disclosure, when the pole core is parallel to the cover plate before convergence or after the pole core is unfolded, a tab free region is formed between the pole core and the solder joint, and a length of the tab free region is determined by a tab lead-out manner of the pole core.

In some examples of the present disclosure, the pole core is constructed as a wound pole core, and when the tab extends out from the pole core in a tab semi-lead-out manner, the thickness of the pole core is D, a length by which the tab extends out from the pole core in an extension direction of the tab is L₂, the length of the tab free region is L₃, and the following relational expression is satisfied: 0.25D<L₃<L₂.

In some examples of the present disclosure, when the tab extends out from the pole core in a tab fully-lead-out manner, the thickness of the pole core is D, a length by which the tab extends out from the pole core in an extension direction of the tab is L₂, the length of the tab free region is L₃, and the following relational expression is satisfied: 0.5D<L₃<L₂.

In some examples of the present disclosure, the plurality of tabs converge and form a tab converging and lead-out position, and in a thickness direction of the pole core, the tab converging and lead-out position includes a zero lead-out position, an intermediate lead-out position, and a biased lead-out position; and the tab converging and lead-out position is located at the zero lead-out position or the biased lead-out position.

In some examples of the present disclosure, the plurality of tabs converge and form a tab converging and lead-out position, and in a thickness direction of the pole core, the tab converging and lead-out position includes a zero lead-out position, an intermediate lead-out position, and a biased lead-out position; and the tab converging and lead-out position is located at the intermediate lead-out position.

In some examples of the present disclosure, the width of the tab protection plate is 8-12 mm.

In some examples of the present disclosure, the solder joint is disposed in a solder joint region of the tab, the solder joint region includes an ultrasonic soldering region and a laser soldering region, and the laser soldering region is located inside the ultrasonic soldering region.

In some examples of the present disclosure, a width of the ultrasonic soldering region in the extension direction of the tab is 4-8 mm.

The battery pack according to the present disclosure includes the above-mentioned battery.

The battery pack according to the present disclosure is provided with the battery in the above embodiments. Because the battery pack according to the present disclosure is provided with the battery in the above embodiments, the battery pack has safety.

The additional aspects and advantages of the present disclosure will be set forth in part in the description below, parts of which will become apparent from the description below, or will be understood by the practice of the present disclosure.

### BRIEF DESCRIPTION OF THE DRAWINGS

FIG. 1 is a cross-sectional view of a battery according to an embodiment of the present disclosure;

FIG. 2 is a schematic diagram of a battery according to an embodiment of the present disclosure when the pole core is parallel to the cover plate after the pole core is unfolded;

FIG. 3 is a schematic diagram showing that the pole core of the battery is located at the zero lead-out position according to an embodiment of the present disclosure;

FIG. 4 is a schematic diagram showing that the pole core of the battery is located at the biased lead-out position according to an embodiment of the present disclosure; and

FIG. 5 is a schematic diagram showing that the pole core of the battery is located at the intermediate lead-out position according to an embodiment of the present disclosure.

### DETAILED DESCRIPTION

Detail description of the embodiments of present disclosure will be made in the following, and examples thereof are illustrated in the drawings, throughout which identical or similar elements or elements of identical or similar functions are represented with identical or similar reference numerals. The embodiments that are described with reference to the accompanying drawings are exemplary, and are only used to interpret the present disclosure, instead limiting the present disclosure.

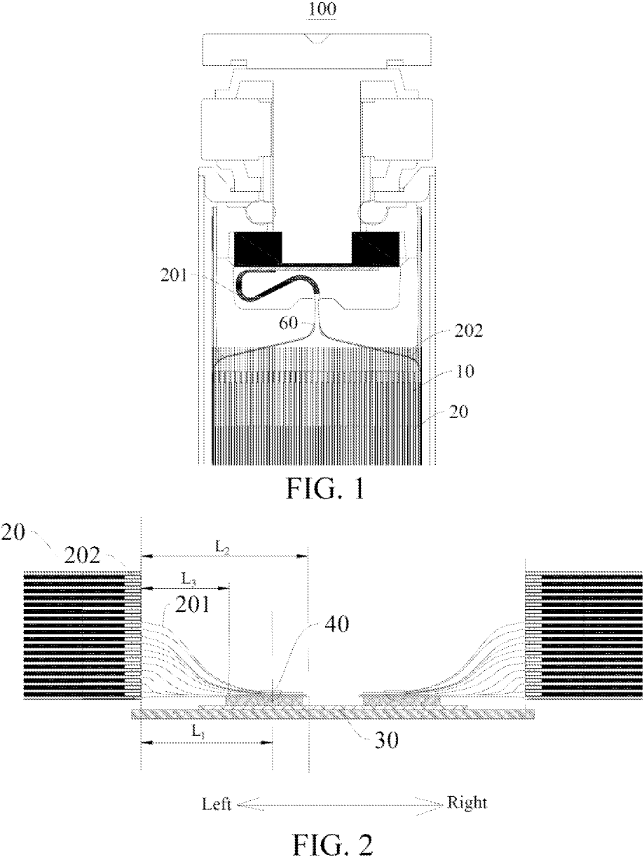

A battery 100 according to the embodiments of the present disclosure will be described below with reference to FIG. 1 to FIG. 5.

As shown in FIG. 1 to FIG. 5, the battery 100 according to the embodiments of the present disclosure includes a cell 10. The cell 10 has at least one pole core 20. Each pole core 20 has a plurality of tabs 201. The plurality of tabs 201 are converged and then soldered to a cover plate 30 of the battery 100 to form a solder joint 40. When the pole core 20 is parallel to the cover plate 30 before convergence or after the pole core 20 is unfolded, which may be understood as that when the pole core 20 is parallel to the cover plate 30 before convergence or when the pole core 20 is parallel to the cover plate 30 after being unfolded, a spacing between the pole core 20 and the solder joint 40 is determined by a thickness of the pole core 20, a tab bending angle of the tab 201, and a width of a tab protection plate at the solder joint 40 in an extension direction of the tab 201.

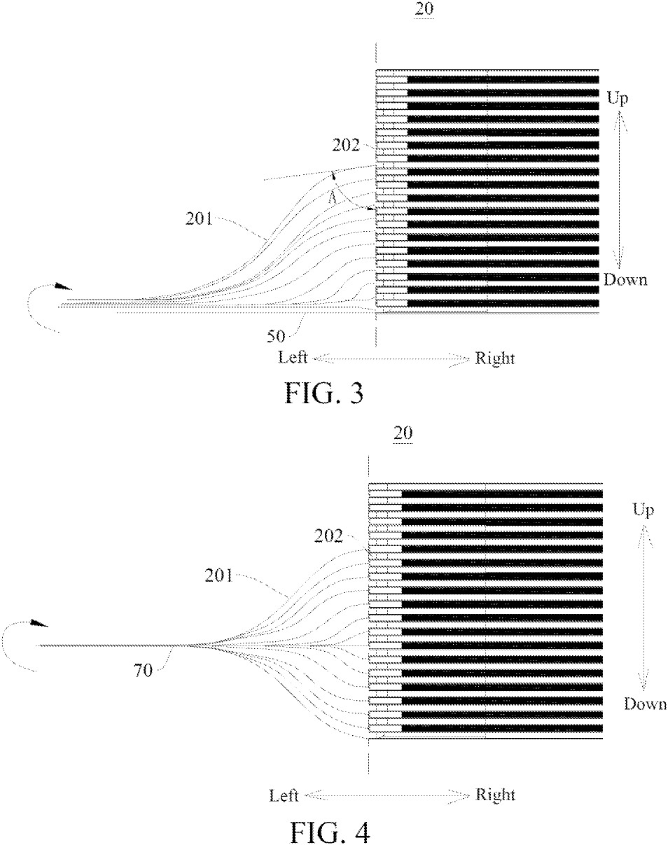

The tab protection plate is provided at the solder joint 40. Each pole core 20 has a plurality of separators 202. A spacing between an end portion of the separator 202 opposite to the solder joint 40 and the solder joint 40 is determined by the thickness of the pole core 20, the tab bending angle of the tab 201, and the width of the tab protection plate in the extension direction of the tab 201. It should be noted that the thickness direction of the pole core 20 refers to a thickness direction of the pole core 20 in FIG. 3 to FIG. 5, and the extension direction of the tab 201 refers to a left-right direction in FIG. 3 to FIG. 5.

By determining the spacing between the pole core 20 and the solder joint 40 according to the thickness of the pole core 20, the tab bending angle of the tab 201, and the width of the tab protection plate at the solder joint 40 in the extension direction of the tab 201, the present disclosure offers a more desirable spacing between the pole core 20 and the solder joint 40, which can prevent the tab 201 from being pulled after bending, and can prevent the tab 201 from being torn, so as to avoid the problem that some electrode plates cannot output electricity, and avoid capacity loss of the cell 10. The present disclosure also offers a desirable movable length of the tab 201 and a desirable bending space for accommodating the tab 201, so as to avoid capacity loss of the cell 10, and prevent the tab 201 from being compressed to cause the positive and negative electrodes of the cell 10 to come into contact with each other, prevent a short circuit of the cell 10, thereby improving the safety of the battery 100 in use.

In some embodiments of the present disclosure, the spacing between the pole core 20 and the solder joint 40 is L₁, the thickness of the pole core 20 is D, the width of the tab protection plate is d₁, the tab bending angle of the tab 201 is A, and the following relational expression is satisfied: L1=D/2*tanA+d₁/2. The tab bending angle A of the tab 201 satisfies the following relational expression: 45°≤A≤135°. The spacing between an end portion of the separator 202 of the pole core 20 opposite to the solder joint 40 and the solder joint 40 is L₁. By such a setting, the present disclosure can further prevent the tab 201 from being pulled after bending, and can prevent the tab 201 from being torn, so as to further avoid the problem that some electrode plates cannot output electricity, and further avoid capacity loss of the cell 10. The present disclosure also offers a more desirable movable length of the tab 201 and a more desirable bending space for accommodating the tab 201, so as to further avoid capacity loss of the cell 10, further prevent the tab 201 from being compressed to cause the positive and negative electrodes of the cell 10 to come into contact with each other, and better prevent a short circuit of the cell 10, thereby improving the safety of the battery 100 in use.

In some embodiments of the present disclosure, the width of the tab protection plate may be set to 8-12 mm. By such a setting, the present disclosure offers a desirable width of the tab protection plate, which can protect the tab 201 better, can further prevent the tab 201 from being pulled after bending, and can further prevent the tab 201 from being torn, so as to further avoid the problem that some electrode plates cannot output electricity, and further avoid capacity loss of the cell 10. The present disclosure also offers a more desirable movable length of the tab 201 and a more desirable bending space for accommodating the tab 201, so as to further avoid capacity loss of the cell 10, further prevent the tab 201 from being compressed to cause the positive and negative electrodes of the cell 10 to come into contact with each other, and better prevent a short circuit of the cell 10, thereby improving the safety of the battery 100 in use.

In some embodiments of the present disclosure, when the pole core 20 is parallel to the cover plate 30 before convergence or after the pole core 20 is unfolded, which may be understood as that when the pole core 20 is parallel to the cover plate 30 before convergence or when the pole core 20 is parallel to the cover plate 30 after being unfolded, as shown in FIG. 2, in the extension direction of the tab 201, a tab free region is formed between the pole core 20 and the solder joint 40. In an embodiment of the present disclosure, after the plurality of tabs 201 are converged, the tab free region is formed between the end portion of separator 202 opposite to the solder joint 40 and the solder joint 40, and the length of the tab free region is determined by the lead-out manner of the tab 201 of the pole core 20. By such a setting, the present disclosure offers a more desirable length of the tab free region, which can further prevent the tab 201 from being pulled after bending, and can further avoid the problem that some electrode plates cannot output electricity, and further avoid capacity loss of the cell 10. The present disclosure also offers a more desirable movable length of the tab 201 and a more desirable bending space for accommodating the tab 201, so as to further avoid capacity loss of the cell 10, further prevent the tab 201 from being compressed to cause the positive and negative electrodes of the cell 10 to come into contact with each other, and better prevent a short circuit of the cell 10, thereby improving the safety of the battery 100 in use. In addition, a more desirable bending angle of the tab 201 can be ensured.

According to an embodiment of the present disclosure, as shown in FIG. 3 and FIG. 4, the pole core 20 is constructed as a wound pole core 20, and when the tab 201 extends out from the pole core 20 in a tab semi-lead-out manner (where it should be noted that the tab semi-lead-out manner means that only one tab 201 is led out for each turn of the pole core 20 after the pole core 20 is wound, and the tab semi-lead-out manner is only applicable to a wound pole core 20), the thickness of the pole core 20 is D, a length by which the tab 201 extends out from the pole core 20 in the extension direction of the tab 201 is L₂ (which can also be understood as that a length by which the tab 201 extends out from the separator 202 in the extension direction of the tab 201 is L₂), the length of the tab free region is L₃, and the following relational expression is satisfied: 0.25D<L₃<L₂. After the plurality of tabs 201 are soldered together, such a setting offers a desirable length of the tab free region, which can prevent the tab 201 from being torn, can prevent the tab 201 from being compressed, and can reduce the risk of short circuit in the cell 10.

In some embodiments of the present disclosure, the plurality of tabs 201 converge and form a tab converging and lead-out position, and in a thickness direction of the pole core 20, the tab converging and lead-out position may include a zero lead-out position 50, an intermediate lead-out position 60, and a biased lead-out position 70. As shown in FIG. 3, the tab converging and lead-out position may be located at the zero lead-out position 50. As shown in FIG. 4, the tab converging and lead-out position may be located at the biased lead-out position 70. The intermediate lead-out position 60 coincides with a central axis 80 of the pole core. In the thickness direction of the pole core 20, the zero lead-out position 50 is located on an axis where the outermost layer of the pole core 20 is located. The biased lead-out position 70 is located between the zero lead-out position 50 and the intermediate lead-out position 60. The larger the thickness of the cell 10, the closer the tab converging and lead-out position is to the intermediate lead-out position 60. The smaller the thickness of the cell 10, the closer the tab 201 converging and lead-out position is to the zero lead-out position 50. Such a setting offers a desirable tab bending angle of the tab 201 suitable, and can ensure that the tab 201 does not compress the separator 202, so as to reduce the risk of damage of the separator 202, thereby reducing the risk of short circuit in the cell 10, and can improve the safety of the battery 100 in use.

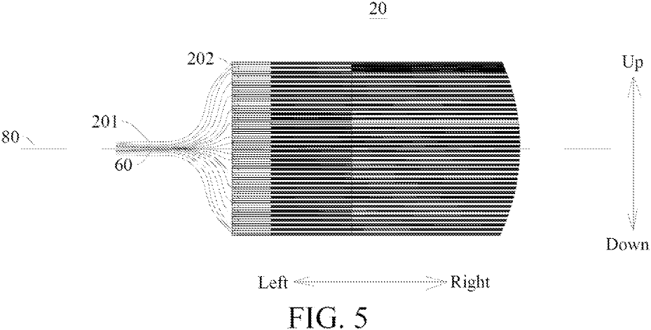

According to another embodiment of the present disclosure, as shown in FIG. 5, when the tab 201 extends out from the pole core 20 in a tab fully-lead-out manner (where it should be noted that the tab fully-lead-out manner means that when the pole core 20 is a laminated pole core, each electrode plate of the pole core 20 has a tab 201 extending out therefrom; or means that when the pole core 20 is a wound pole core, each turn of electrode plate of the pole core 20 is symmetrically provided with two tabs 201 by taking the diameter of the pole core 20 as the symmetric center; the laminated pole core 20 needs to adopt the tab fully-lead-out manner, and the wound pole core 20 may or may not adopt the tab fully-lead-out manner), the thickness of the pole core 20 is D, a length by which the tab 201 extends out from the pole core 20 in the extension direction of the tab 201 is L₂ (which can also be understood as that a length by which the tab 201 extends out from the separator 202 in the extension direction of the tab 201 is L₂), the length of the tab free region is L₃, and the following relational expression is satisfied: 0.5D<L₃<L₂. Such a setting offers a desirable length of the tab free region, which can prevent the tab 201 from being torn, can prevent the tab 201 from being compressed, and can reduce the risk of short circuit in the cell 10.

Further, the plurality of tabs 201 converge and form a tab converging and lead-out position, and in a thickness direction of the pole core 20, the tab converging and lead-out position includes a zero lead-out position 50, an intermediate lead-out position 60, and a biased lead-out position 70. As shown in FIG. 5, the tab converging and lead-out position may be located at the intermediate lead-out position 60. Such a setting offers a desirable tab bending angle of the tab 201 suitable, and can ensure that the tab 201 does not compress the separator 202, so as to reduce the risk of damage of the separator 202, thereby reducing the risk of short circuit in the cell 10, and can improve the safety of the battery 100 in use.

In some embodiments of the present disclosure, the solder joint 40 may be disposed in a solder joint region of the tab 201, the solder joint region may include an ultrasonic soldering region and a laser soldering region, and the laser soldering region is located inside the ultrasonic soldering region. That is, the laser soldering region overlaps with the ultrasonic soldering region. The plurality of tabs 201 are first soldered together in the ultrasonic soldering region by ultrasonic soldering, and the plurality of tabs 201 are converged. Then the converged tabs 201 are soldered on the cover plate 30 in the laser soldering region by laser soldering. By means of such a setting, the plurality of tabs 201 can be reliably soldered to the cover plate 30, and can prevent the plurality of tabs 201 from being separated from the cover plate 30, thereby ensuring the working reliability of the battery 100.

Further, a width of the ultrasonic soldering region in the extension direction of the tab 201 is 4-8 mm. Preferably, the width of the ultrasonic soldering region is set to 6 mm. Such a setting offers a desirable width of the ultrasonic soldering region can reliably solder together the plurality of tabs 201, and can also ensure the soldering quality. It should be noted that the spacing between the pole core 20 and the solder joint refers to a spacing from the pole core 20 to the center of the laser soldering joint.

The battery pack according to the embodiments of the present disclosure includes the battery 100 of the above embodiments, and disposing the battery 100 in the battery pack offers a more desirable spacing between the pole core 20 and the solder joint 40, which can prevent the tab 201 from being pulled after bending, and can prevent the tab 201 from being torn, so as to avoid capacity loss of the cell 10; and also offers a desirable movable length of the tab 201 and a desirable bending space, so as to avoid capacity loss of the cell 10, and prevent the tab 201 from being compressed, thereby improving the safety of the battery 100 in use.

In the description of this specification, the description of the reference terms such as “an embodiment”, “some embodiments”, “exemplary embodiments”, “example”, “specific example”, or “some examples” means that the specific features, structures, materials or characteristics described with reference to the embodiment or example are included in at least one embodiment or example of the present disclosure. In this specification, exemplary descriptions of the foregoing terms do not necessarily refer to the same embodiment or example. In addition, the described specific features, structures, materials, or characteristics may be combined in a proper manner in any one or more of the embodiments or examples.

Although the embodiments of the present disclosure have been shown and described, a person skilled in the art can understand that changes, alternatives, and modifications can be made in the embodiments without departing from the principle and the purpose of the present disclosure, and the scope of the present disclosure is as defined by the claims and their equivalents.

What is claimed is:

1. A battery, comprising:
a cell, wherein the cell has at least one pole core, each pole core has a plurality of tabs, the plurality of tabs are converged and then soldered to a cover plate of the battery to form a solder joint, and when the pole core is parallel to the cover plate before convergence or after the pole core is unfolded, a spacing between the pole core and the solder joint is determined by a thickness of the pole core, a tab bending angle of the tab, and a width of a tab protection plate at the solder joint, a thickness of the pole core is D.

2. The battery according to claim 1, wherein the spacing between the pole core and the solder joint is L₁, the width of the tab protection plate is d₁, the tab bending angle of the tab is A, and the following relational expression is satisfied: L₁=D/2*tanA+d₁/2.

3. The battery according to claim 2, wherein 45°≤A≤135°.

4. The battery according to claim 1, wherein when the pole core is parallel to the cover plate before convergence or after the pole core is unfolded, a tab free region is formed between the pole core and the solder joint, and a length of the tab free region is determined by a tab lead-out manner of the pole core, a length by which the tab extends out from the pole core in an extension direction of the tab is L₂, a length of the tab free region is L₃.

5. The battery according to claim 2, wherein when the pole core is parallel to the cover plate before convergence or after the pole core is unfolded, a tab free region is formed between the pole core and the solder joint, and a length of the tab free region is determined by a tab lead-out manner of the pole core, a length by which the tab extends out from the pole core in an extension direction of the tab is L₂, a length of the tab free region is L₃.

6. The battery according to claim 3, wherein when the pole core is parallel to the cover plate before convergence or after the pole core is unfolded, a tab free region is formed between the pole core and the solder j oint, and a length of the tab free region is determined by a tab lead-out manner of the pole core, a length by which the tab extends out from the pole core in an extension direction of the tab is L₂, a length of the tab free region is L₃.

7. The battery according to claim 4, wherein the pole core is constructed as a wound pole core, and when the tab extends out from the pole core in a tab semi-lead-out manner,, and the following relational expression is satisfied: 0.25D<L₃<L₂.

8. The battery according to claim 4, wherein when the tab extends out from the pole core in a tab fully-lead-out manner, and the following relational expression is satisfied: 0.5D<L₃<L₂.

9. The battery according to claim 7, wherein when the tab extends out from the pole core in a tab fully-lead-out manner, and the following relational expression is satisfied: 0.5D<L₃<L₂.

10. The battery according to claim 7, wherein the plurality of tabs converge and form a tab converging and lead-out position, and in a thickness direction of the pole core, the tab converging and lead-out position comprises a zero lead-out position, an intermediate lead-out position, and a biased lead-out position; and
the tab converging and lead-out position is located at the zero lead-out position or the biased lead-out position.

11. The battery according to claim 8, wherein the plurality of tabs converge and form a tab converging and lead-out position, and in a thickness direction of the pole core, the tab converging and lead-out position comprises a zero lead-out position, an intermediate lead-out position, and a biased lead-out position; and
the tab converging and lead-out position is located at the zero lead-out position or the biased lead-out position.

12. The battery according to claim 9, wherein the plurality of tabs converge and form a tab converging and lead-out position, and in a thickness direction of the pole core, the tab converging and lead-out position comprises a zero lead-out position, an intermediate lead-out position, and a biased lead-out position; and
the tab converging and lead-out position is located at the zero lead-out position or the biased lead-out position.

13. The battery according to claim 8, wherein the plurality of tabs converge and form a tab converging and lead-out position, and in a thickness direction of the pole core, the tab converging and lead-out position comprises a zero lead-out position, an intermediate lead-out position, and a biased lead-out position; and
the tab converging and lead-out position is located at the intermediate lead-out position.

14. The battery according to claim 9, wherein the plurality of tabs converge and form a tab converging and lead-out position, and in a thickness direction of the pole core, the tab converging and lead-out position comprises a zero lead-out position, an intermediate lead-out position, and a biased lead-out position; and
the tab converging and lead-out position is located at the intermediate lead-out position.

15. The battery according to claim 1, wherein the width of the tab protection plate is 8-12 mm.

16. The battery according to claim 1, wherein the solder joint is disposed in a solder joint region of the tab, the solder joint region comprises an ultrasonic soldering region and a laser soldering region, and the laser soldering region is located inside the ultrasonic soldering region.

17. The battery according to claim 16, wherein a width of the ultrasonic soldering region in the extension direction of the tab is 4-8 mm.

18. The battery according to claim 6, wherein the pole core is constructed as a wound pole core, and when the tab extends out from the pole core in a tab semi-lead-out manner, , and the following relational expression is satisfied: 0.25D<L₃<L₂.

19. The battery according to claim 6, wherein when the tab extends out from the pole core in a tab fully-lead-out manner, and the following relational expression is satisfied: 0.5D<L₃<L₂.

20. A battery pack, comprising the battery according to claim 1.
